(19) United States
(12) Patent Application Publication
(10) Pub. No.: US 2026/0316920 A1
(43) Pub. Date: Oct. 15, 2026

(54) APPARATUS FOR TORQUE TRANSMISSION

(71) Applicant: TRISKEL MARINE LIMITED, Hayle, Cornwall (GB)

(72) Inventors: Christopher Lack, Salisbury (GB); Jason Crawford, Burradoo (AU)

(21) Appl. No.: 19/484,860

(22) PCT Filed: May 15, 2024
(86) PCT No.: PCT/GB2024/051264

§ 371 Date: Nov. 15, 2025

(30) Foreign Application Priority Data
May 15, 2023 (GB) 2307200.2

(51) Int. Cl. B63H 23/12; B63H 21/14; B63H 21/17; B63H 23/30; B63H 23/32; F16D 3/12; F16D 41/069; F16D 47/02; F16D 47/04

(52) U.S. Cl. CPC B63H 23/12; B63H 21/14; B63H 21/17; B63H 23/30; B63H 23/32; F16D 3/12; F16D 41/069; F16D 47/02; F16D 47/04

(57) ABSTRACT

Apparatus for transmitting torque in boat propulsion from an extrinsic drive means to an extrinsic load means, the apparatus comprising a damper plate having a damper plate drive part and a damper plate load part, and an overrunning clutch having an overrunning clutch drive part and an overrunning clutch load part, wherein the damper plate drive part is adapted to be in mechanical connection with said drive means, the damper plate load part is in mechanical connection with the overrunning clutch drive part, and the overrunning clutch load part is adapted to be in mechanical connection with said load means, the drive means not being directly mechanically connected to the load means, wherein the damper plate has a relatively back plate which acts as the damper plate drive part, more than one damper elements attached to the back plate, and a relatively front plate attached to the one or more damper elements and wherein the damper elements comprise a resilient rubber or plastics material.

### FIELD OF THE INVENTION

The present invention relates to apparatus for torque transmission; especially but not exclusively in the field of boat propulsion.

### BACKGROUND TO THE INVENTION

The output from an internal combustion engine tends not to be a consistent rotational speed, and the torque provided is generally not consistent over the combustion cycle. Since the development of the internal combustion engine, efforts have been made to provide a more consistent or smooth power and torque output—such as by providing several pistons, using rotary engines, electronic controls and the like.

However, in some applications—such as boat propulsion—smaller engines are useful. For example, marine inboard engines are often diesel engines, typically four-cylinder engines, which often have poor consistency of power and torque output.

### SUMMARY OF INVENTION

The present disclosure is as set out in the claims. Aspects will be described in further detail.

A first aspect of the present invention provides apparatus for transmitting torque from a drive means to a load means to provide a more consistent rotational speed and torque to the load means.

A second aspect of the present invention provides a drive unit suitable for driving a boat, the drive unit comprising an internal combustion engine and an electric motor, connected together by an arrangement for transmitting torque from a drive means to a load means.

The first aspect of the present invention provides apparatus for transmitting torque from a drive means to a load means, the apparatus comprising a damper plate having a damper plate drive part and a damper plate load part, and an overrunning clutch assembly having an overrunning clutch drive part and an overrunning clutch load part, wherein the damper plate drive part is adapted to be in mechanical connection with said drive means, the damper plate load part is in mechanical connection with the overrunning clutch drive part, and the overrunning clutch load part is adapted to be in mechanical connection with said load means, the drive means not being directly mechanically connected to the load means.

Thus, the drive means is not directly mechanically connected to the load means. Instead, torque is transmitted from drive to load via the intermediaries of the damper plate and overrunning clutch. The drive means and load means themselves are not within the scope of the first aspect.

As a typical drive means—such as an internal combustion engine—does not provide consistent rotational speed and torque, the apparatus provides a more consistent rotational speed and torque to the load means than a direct connection of the load means to the drive means would provide. Furthermore, the apparatus prevents the load means from transmitting torque back to the drive means. This is important in certain situations, such as when the drive means is slowing down or if the load means can also provide power or torque—for example if the load means can also act as a motor. The overrunning clutch assembly further helps smooth the rotational speed by allowing the load means to rotate faster than the drive means. Thus, if the drive means slows down the load means can freewheel until the drive means exceeds the rotational speed of the load means.

This arrangement also provides for a compact apparatus providing the functionality efficiently within a relatively short axial distance.

Whilst some of the individual components may be known in other applications, the combination of the features of the invention provide an improved performance and compact overall size to effect that performance. The invention can also reduce material requirements, improve reliability and provide for lower manufacturing and distribution costs—including environmental costs.

The damper plate may have a back plate which acts as the damper plate drive part, one or more damper elements attached to the back plate, and a front plate attached to the one or more damper elements. In other words, the one or more damper elements are arranged between the back plate and the front plate. The or each damper element comprises a resilient portion; thus the or each damper element can absorb or dampen torsional impact or noise of the power stroke of the drive means so that the front plate rotates with a more consistent speed and provides more
consistent torque to a load attached to it. The or each damper element can also absorb or dampen if the speed of the drive means increases or decreases.

The back plate may comprise a disc with a central aperture. The central aperture of the back plate may be sized to accommodate parts of the overrunning clutch assembly whilst allowing the overrunning clutch to rotate independently of the back plate. Within the central aperture of the back plate may be arranged a radial bearing and one or more snap rings.

One or more damper elements may be attached to the back plate mechanically, or by adhesion, or both.

The back plate may further comprise one or more buttresses to hold one or more of the damper elements to the back plate. A buttress may be formed by an annular wall arranged substantially concentrically around said central aperture of the back plate on a face of the back plate which faces towards the front plate in use. An annular wall may be continuous around the circumference or may be divided into segments with gaps therebetween. A buttress may be formed by one or more tabs extending substantially radially on said face of the back plate which faces towards the front plate in use. The back plate may have buttresses formed by both an annular wall and one or more tabs extending radially on said face of the back plate which faces towards the front plate in use.

Alternatively, a buttress may be formed by a recess in the back plate.

One or more damper elements may be positioned with one or more gaps therebetween.

The back plate may comprise a plurality of apertures for connecting the back plate to a drive means. The apertures may be approximately equally spaced around the circumference of the back plate.

One or more damper elements may comprise a resilient rubber or plastics material. The material of the one or more damper elements may be selected to suit characteristics of a drive means intended to be used with the apparatus. One or more damper elements may comprise polyurethane.

A rubber or plastics damper element may be shaped as a segment of a ring. A rubber or plastics damper element may comprise one or more voids. The number, shape, size etc. of said voids can be selected to provide a desired amount of rigidity and resilience of the one or more damper elements.

One or more damper elements may comprise a spring.

A damper element comprising a spring may be arranged with a compression/expansion axis thereof approximately circumferential with respect to the axis of the damper plate.

A plurality of damper elements may be arranged approximately equally spaced circumferentially around the axis of the damper plate.

The back plate may comprise at least five damper elements. The back plate may comprise six to eight damper elements. The back plate may comprise six damper elements.

The back plate may be sized to match a flywheel of the drive means.

The damper plate may comprise a front plate which acts as the damper plate load part. The front plate may comprise a disc with a central aperture. The back plate and front plate may be arranged so that the respective central apertures are aligned with each other along an axis of the damper plate, so that the damper plate is rotationally symmetric around the axis, in use. This provides for transmission of torque along a single axis. This can provide for a compact apparatus to achieve the performance. Furthermore, it can provide for a retrofit apparatus to replace an existing transmission apparatus.

The front plate may comprise an annular wall arranged substantially concentrically around said central aperture of the front plate on a face of the front plate which faces towards the back plate in use. An annular wall may be continuous around the circumference or may be divided into segments with gaps therebetween. The front plate may comprise one or more tabs which extend substantially radially inwards from the edge of the front plate towards the central aperture. The tabs may be sized and spaced to fit between gaps between one or more damper elements.

The central aperture of the front plate may be sized to accommodate and adapted to engage with one or more part(s) of the overrunning clutch assembly.

Thus, in use, the damper plate can transfer a turning force applied to the back plate, via one or more damper elements to the front plate and in turn to the overrunning clutch assembly. The transfer of the turning force is not direct, and the one or more damper elements provide damping or smoothing of variations in the turning force and speed of drive means driving the back plate.

The size of back plate and overall size of damper plate are selected as appropriate to the power output and torque of the drive means. A typical axial length of the damper plate is 60 mm. This provides an overall compact arrangement for providing drive along a single axis.

The overrunning clutch assembly may have an annular portion which is adapted to engage with the front plate of the damper plate, which acts as the overrunning clutch assembly drive part.

The overrunning clutch assembly may comprise one or more lip seals. The overrunning clutch assembly may comprise one or more snap rings.

The overrunning clutch assembly may have a shaft which acts as the overrunning clutch load part.

The shaft may have a splined portion. The splined portion can engage with a load means in order to drive it.

The overrunning clutch assembly may comprise a sprag clutch.

The second aspect of the present invention provides a drive unit suitable for driving a boat, the drive unit comprising an internal combustion engine and an electric motor, connected together by an apparatus for transmitting torque from a drive means to a load means, the apparatus comprising a damper plate having a damper plate drive part and a damper plate load part, and an overrunning clutch having an overrunning clutch drive part and an overrunning clutch load part, wherein the damper plate drive part is adapted to be in mechanical connection with said drive means, the damper plate load part is in mechanical connection with the overrunning clutch drive part, and the overrunning clutch load part is adapted to be in mechanical connection with said load means, the drive means not being directly mechanically connected to the load means.

The drive means may be an internal combustion engine. The load means may be an electric motor or an electric generator or a device adapted to act as both an electric motor and generator. The load means may be a gearbox. The load means may be a propellor.

### DETAILED DESCRIPTION OF THE INVENTION

Exemplary embodiments of the present invention will now be described in more detail, with reference to the accompanying drawings, in which:

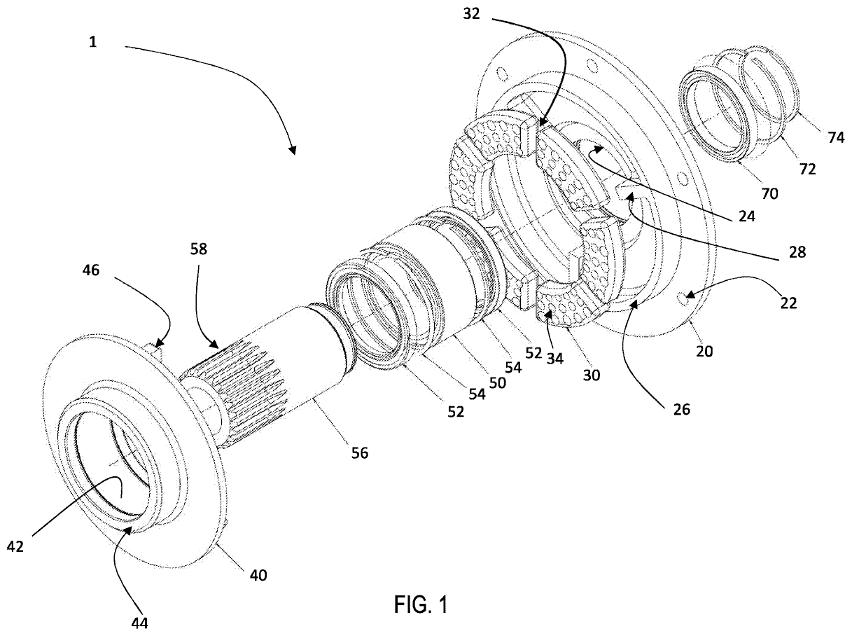

FIG. 1 is an exploded view of apparatus for transmitting torque from a drive means to a load means exemplifying the first aspect of the present invention;

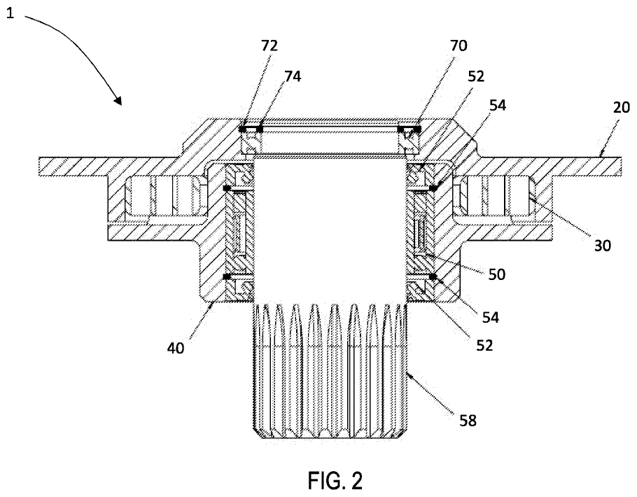

FIG. 2 shows a cross section of the same arrangement as shown in FIG. 1;

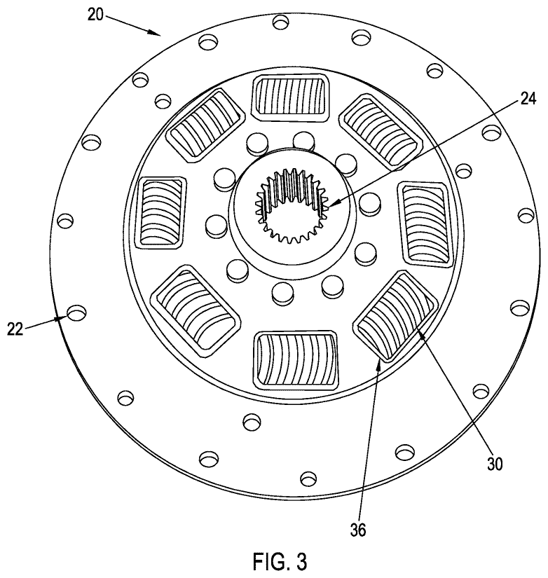

FIG. 3 shows an alternative exemplary embodiment of a back plate as part of the apparatus of the present invention; and

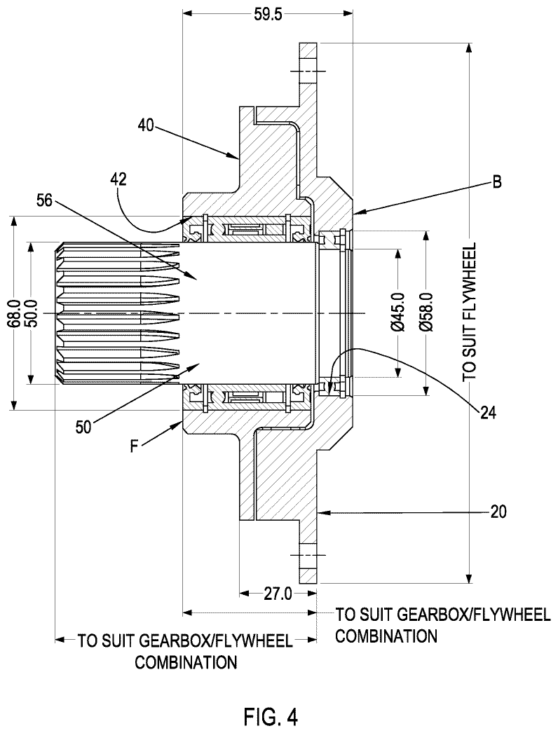

FIG. 4 shows a cross section of exemplary elements of the present invention, to show some exemplary dimensions.

In FIG. 1, the apparatus 1 has a damper plate having a disc shaped back plate 20, which acts as the damper plate drive part, which has apertures 22 distributed approximately equally around the circumference of the back plate 20. Not all of the apertures 22 are labelled in FIG. 1, to aid clarity. The apertures 22 are intended to connect the back plate 20 to a drive means (not shown in FIG. 1 and not within the scope of the first aspect). The back plate 20 has a central aperture 24 which is large enough to accommodate parts of the overrunning clutch assembly 50 of the apparatus 1 without mechanical engagement between the overrunning clutch assembly 50 and the back plate 20. The overrunning clutch assembly 50 has a radial bearing 70 and snap rings 72, 74 to hold it within the central aperture 24. Other arrangements could be used to hold the overrunning clutch assembly 50 similarly.

The back plate 20 has an annular wall 26 arranged concentrically with the central aperture 24, on the face of the back plate 20 which faces towards the front plate 40 of the damper plate in use. The annular wall 26 has tabs 28 extending perpendicularly from the wall 26 (i.e. radially) towards the central aperture 24. Not all of the tabs 28 are labelled in FIG. 1, to aid clarity. The annular wall 26 and the tabs 28 provide a series of recesses into which damper elements 30 are placed. Not all of the damper elements 30 are labelled in FIG. 1, to aid clarity. The damper elements 30 are approximately equally spaced around the central aperture 24. The annular wall 26 and tabs 28 support the damper elements 30 to be held in position in use and move with the back plate 20. The damper elements 30 in this exemplary embodiment are shaped as segments of a ring. In such an arrangement the damper elements 30 are buttressed by the annular wall 26 and tabs 28 in use. In this exemplary embodiment, there are twice as many damper elements 30 as there are tabs 28. Thus, each damper element 30 is buttressed by a tab 28 on one side, and there are gaps 32 between some of the damper elements 30. Not all of the gaps 32 are labelled in FIG. 1, to aid clarity.

The damper elements 30 have a series of voids 34 formed therein. The number, shape, size etc. of such voids 34 can be selected to provide a desired amount of rigidity and resilience of the damper elements 30. The material of the damper elements 30 can be selected to provide a desired amount of rigidity and resilience thereof.

The damper plate has a disc shaped front plate 40 having a central aperture 42 and an annular wall 44 arranged concentrically with the central aperture 42, and on the face of the front plate 40 which faces away from the back plate 20. On the face of the front plate 40 which faces towards the back plate 20 in use are tabs 46 which extend radially inwards from the edge of the front plate 40 towards the central aperture 42. The tabs 46 are sized and spaced to fit between the gaps 32 between some of the damper elements 30 of the back plate 20. The central aperture 42 of the front plate 40 is sized to accommodate and engage with parts of the overrunning clutch assembly 50.

Thus, in use, the damper plate can transfer a turning force applied to the back plate 20, via the damper elements 30 to the front plate 40 and in turn to the overrunning clutch assembly 50. The transfer of the turning force is not direct, and the resilient damper elements 30 provide damping or smoothing of variations in the turning force and speed of drive means driving the back plate 20.

The apparatus 1 has an overrunning clutch assembly 50 which has a sprag clutch, lip seals 52, snap rings 54 and a shaft 56. The shaft 56 has a splined region 58 towards an end away from the back plate 20. If the overrunning clutch assembly 50 is driven by a turning force in one direction from the front plate 40 of the damper plate then said turning force is transmitted to the shaft 56; in turn the splined region 58 of the shaft 56 can drive a load means (not shown in FIG. 1 and not within the scope of the first aspect). If the shaft 56 is rotating faster in one direction than the front plate 40 then the overrunning clutch assembly 50 will not transmit a turning force back to the front plate 40.

Thus, in use, the apparatus prevents the load means from transmitting torque back to the drive means.

FIG. 2 shows the apparatus 1 of FIG. 1 in cross section, assembled for use.

Elements have been numbered as in FIG. 1.

In FIG. 3, an alternative back plate is shown, with elements labelled with the same labels as in FIG. 1, where those elements correspond. A back plate 20, which can act as the damper plate drive part of the apparatus of the present invention, has apertures 22 distributed approximately equally around the circumference of the back plate 20. Not all of the apertures 22 are labelled in FIG. 3, to aid clarity. The apertures 22 are intended to connect the back plate 20 to a drive means (not shown in FIG. 3). The back plate 20 has a central aperture 24. A series of damper elements 30 are spaced approximately equally around the central aperture 24. The damper elements 30 are springs, each having a compression/expansion axis approximately circumferential with respect to the central aperture 24. The damper elements 30 are located within recesses 36 formed within the back plate 20. Not all of the damper elements 30 and recesses 36 are labelled, to aid clarity.

In FIG. 4, exemplary elements of an apparatus exemplifying the present invention are shown, with certain exemplary dimensions. In FIG. 4, certain elements are labelled with the same labels as in FIGS. 1 and 3, where those elements correspond. The central aperture 42 of the front plate 40 has a diameter of approx. 68 mm to match the size of the overrunning clutch assembly 50. The shaft 56 has a diameter of approx. 50 mm.

The central aperture 24 of the back plate 20 has a diameter of approx. 58 mm.

The overall axial length of the damper plate, i.e. the distance between the back B of the back plate 20 to the front F of the front plate 40—not including the shaft 56—is approx. 59.5 mm.

1. Apparatus for transmitting torque in boat propulsion from an extrinsic drive means to an extrinsic load means, the apparatus comprising a damper plate having a damper plate drive part and a damper plate load part, and an overrunning clutch having an overrunning clutch drive part and an overrunning clutch load part, wherein the damper plate drive part is adapted to be in mechanical connection with said extrinsic drive means, the damper plate load part is in mechanical connection with the overrunning clutch drive part, and the overrunning clutch load part is adapted to be in mechanical connection with said extrinsic load means, the extrinsic drive means not being directly mechanically connected to the load means, wherein the damper plate has a back plate which acts as the damper plate drive part, more than one damper elements attached to the back plate wherein the back plate further comprises one or more buttresses adapted to hold the damper elements to the back plate, and a front plate attached to the damper elements and wherein the damper elements comprise a resilient rubber or plastics material.

2. Apparatus according to claim 1 wherein the back plate comprises a disc with a central aperture.

3. Apparatus according to claim 2, wherein the central aperture of the back plate is sized to accommodate parts of the overrunning clutch whilst allowing the overrunning clutch to rotate independently of the back plate.

4. (canceled)

5. Apparatus according to claim 1, wherein a buttress is formed by an annular wall arranged substantially concentrically around said central aperture of the back plate on a face of the back plate which faces towards the front plate in use.

6. Apparatus according to claim 1, wherein a buttress is formed by one or more tabs extending substantially radially on said face of the back plate which faces towards the front plate in use.

7. Apparatus according to claim 1, wherein the damper elements further comprise a spring.

8. Apparatus according to claim 1, wherein the front plate comprises a disc with a central aperture.

9. Apparatus according to claim 8, wherein the back plate and the front plate are arranged so that the respective central apertures are aligned with each other along an axis of the damper plate, so that in use, the damper plate is rotationally symmetric around the axis.

10. Apparatus according to claim 8, wherein the front plate comprises an annular wall arranged substantially concentrically around said central aperture of the front plate on a face of the front plate which faces towards the back plate in use.

11. Apparatus according to claim 8, wherein front plate comprises one or more tabs which extend substantially radially inwards from the edge of the front plate towards the central aperture.

12. Apparatus according to claim 8, wherein the central aperture of the front plate is sized to accommodate and adapted to engage with one or more part(s) of the overrunning clutch.

13. A drive unit suitable for driving a boat, the drive unit comprising an internal combustion engine and an electric motor, connected together by an apparatus for transmitting torque from a drive means to a load means, the apparatus comprising a damper plate having a damper plate drive part and a damper plate load part, and an overrunning clutch, having an overrunning clutch drive part and an overrunning clutch load part, wherein the damper plate drive part is adapted to be in mechanical connection with said drive means, the damper plate load part is in mechanical connection with the overrunning clutch drive part, and the overrunning clutch load part is adapted to be in mechanical connection with said load means, the drive means not being directly mechanically connected to the load means, wherein the damper plate has a back plate which acts as the damper plate drive part, more than one damper elements attached to the back plate, one or more buttresses to hold one or more of the damper elements to the back plate, and a front plate attached to the damper elements and wherein the damper elements comprise a resilient rubber or plastics material.
